(19) United States
(12) Patent Application Publication
(10) Pub. No.: US 2024/0322678 A1
(43) Pub. Date: Sep. 26, 2024

(54) CHARGE PUMP CIRCUIT, DISPLAY DRIVER AND DISPLAY DEVICE

(71) Applicant: LAPIS Technology Co., Ltd., Yokohama (JP)

(72) Inventor: Hiroshi TSUCHI, Yokohama (JP)

(73) Assignee: LAPIS Technology Co., Ltd., Yokohama (JP)

(21) Appl. No.: 18/604,442

(22) Filed: Mar. 13, 2024

(30) Foreign Application Priority Data
Mar. 23, 2023 (JP) 2023-046144

(51) Int. Cl. H02M 3/07; G09G 3/20

(52) U.S. Cl. CPC H02M 3/07; G09G 3/20; G09G 2330/021; G09G 2330/028

(57) ABSTRACT

In the disclosure, in generating an output voltage that is stepped up or down to a target voltage value by repeatedly charging/discharging a capacitor according to a charge pump driving signal, before a voltage value of the output voltage reaches a target voltage value, driving capability of an output buffer that generates the charge pump driving signal is decreased.

### CROSS-REFERENCE TO RELATED APPLICATION

This application claims priority under 35 USC 119 from Japanese Patent application No. 2023-046144 filed on Mar. 23, 2023, the disclosure of which is incorporated by reference herein.

### BACKGROUND

### Technical Field

The disclosure relates to a charge pump circuit configured to generate a power supply voltage, a display driver including the charge pump circuit, and a display device.

### Description of Related Art

In a data driver configured to supply a driving signal to a liquid crystal or an organic EL display panel based on a video signal, a power supply circuit configured to generate an internal power supply voltage in order to operate various circuits included in the data driver based on a predetermined power supply voltage is provided. The internal power supply voltage outputs current corresponding to the operations of the various circuits.

In addition, as such a power supply circuit, a device equipped with a charge pump circuit that steps down or steps up a voltage value of the predetermined power supply voltage has been proposed (for example, see Japanese Patent Laid-Open No. 2002-207441).

The charge pump circuit includes at least, for example, a diode configured to receive a predetermined power supply voltage at an anode, a capacitive element having one end connected to a cathode of the diode, and a driving circuit configured to charge/discharge the capacitive element, and further includes an output node to which a voltage generated at a connecting node between a cathode of the diode and the capacitive element is guided. The driving circuit alternately repeatedly executes a charging operation of charging the capacitive element and a discharging operation of discharging the capacitive element by alternately applying binary (logic level 0, 1) voltages according to a clock signal to the other end of the capacitive element. Further, the driving circuit stops an application operation of binary voltages with respect to the capacitive element after the voltage generated at the output node exceeds a predetermined target voltage value, and charges/discharges the capacitive element by restarting the application operation of the binary voltages again after the voltage generated at the output node has fallen below the target voltage value. Accordingly, a voltage obtained by stepping up or down a predetermined power supply voltage and causing a voltage value of the output node to converge to the target voltage value is generated as an internal power supply voltage.

Incidentally, in the charge pump circuit, if the voltage is stepped up (down) quickly, a ripple that occurs upon stepping down (up) of the voltage after the voltage reaches a target voltage is increased.

Here, the disclosure provides a charge pump circuit capable of reducing a ripple, a display driver including the charge pump circuit, and a display device.

### SUMMARY

A charge pump circuit according to the disclosure is a charge pump circuit including a capacitor and configured to step up or down a voltage of an output node to reach a target voltage value and output the voltage of the output node as the output voltage by deriving a voltage generated at a first node of one end of the capacitor to an output node while repeatedly charging/discharging the capacitor according to a charge pump driving signal, the charge pump circuit including: a comparator circuit configured to compare magnitudes of a return voltage, whose voltage value changes according to the output voltage, and a first reference voltage corresponding to the target voltage value to generate a first comparison result signal indicating whether the return voltage exceeds the first reference voltage, and compare magnitudes of a second reference voltage corresponding to the voltage value before the target voltage value and the return voltage to generate a second comparison result signal indicating whether the return voltage exceeds the second reference voltage; a first control circuit configured to generate a charge pump control signal that stops charging/discharging of the capacitor when the first comparison result signal indicates that the return voltage exceeds the first reference voltage, and an oscillation signal that performs charging/discharging of the capacitor when the first comparison result signal indicates that the return voltage does not exceed the first reference voltage as the charge pump control signal; a second control circuit configured to generate a driving capability control signal that indicates a low driving mode when the second comparison result signal indicates that the return voltage exceeds the second reference voltage and a high driving mode when the second comparison result signal indicates that the return voltage does not exceed the second reference voltage; and an output buffer configured to output a signal obtained by amplifying the charge pump control signal via a second node as the charge pump driving signal, wherein the output buffer reduces current flowing to the second node when the driving capability control signal indicates the low driving mode compared to the case of indicating the high driving mode.

A display driver according to the disclosure is a display driver configured to drive a display panel on which a plurality of display cells is disposed based on a video signal, the display driver including: a circuit group configured to generate a signal group that drives the display panel and supply the signal group to the display panel, and a power supply circuit including the above-mentioned charge pump circuit and configured to generate a power supply voltage that operates the circuit group based on the output voltage output from the charge pump circuit.

A display device according to the disclosure is a display device having a display panel on which a plurality of display cells are disposed, and a display driver configured to generate a signal group that drives the display panel based on a video signal, the display driver including: a circuit group configured to generate a signal group that drives the display panel and supply the signal group to the display panel, and a power supply circuit including the charge pump circuit and configured to generate a power supply voltage that operates the circuit group based on the output voltage output from the charge pump circuit.

### BRIEF DESCRIPTION OF THE DRAWINGS

FIG. 1 is a circuit diagram showing a configuration of a charge pump circuit 100_1 as a first example according to the disclosure.

FIG. 2 is a view showing an operation state of a comparator and a charge pump circuit.

FIG. 3 is a time chart showing an operation of the charge pump circuit 100_1.

FIG. 4 is a circuit diagram showing a configuration of a charge pump circuit 100_2 as a second example.

FIG. 5 is a circuit diagram showing an internal configuration of a comparator circuit 10.

FIG. 6 is a circuit diagram showing a configuration of a charge pump circuit 100_3 as a third example.

FIG. 7 is a circuit diagram showing a configuration of a charge pump circuit 100_4 as a fourth example.

FIG. 8 is a view showing an operation state of a comparator circuit 10B and the charge pump circuit 100_4 shown in FIG. 7.

FIG. 9 is a circuit diagram showing an internal configuration of the comparator circuit 10B.

FIG. 10 is a block diagram showing a schematic configuration of a display device 300.

### DESCRIPTION OF THE EMBODIMENTS

In the charge pump circuit according to the disclosure, in generating an output voltage that is stepped up or down to a target voltage value by repeatedly charging/discharging a capacitor according to a charge pump driving signal, before a voltage value of the output voltage reaches a target voltage value, driving capability of an output buffer that generates the charge pump driving signal is decreased.

Accordingly, before the target voltage value, since the voltage change rate upon step-up or step-down of the output voltage by the charge pump operation is lowered, it is possible to suppress a ripple generated at the output voltage.

### Example 1

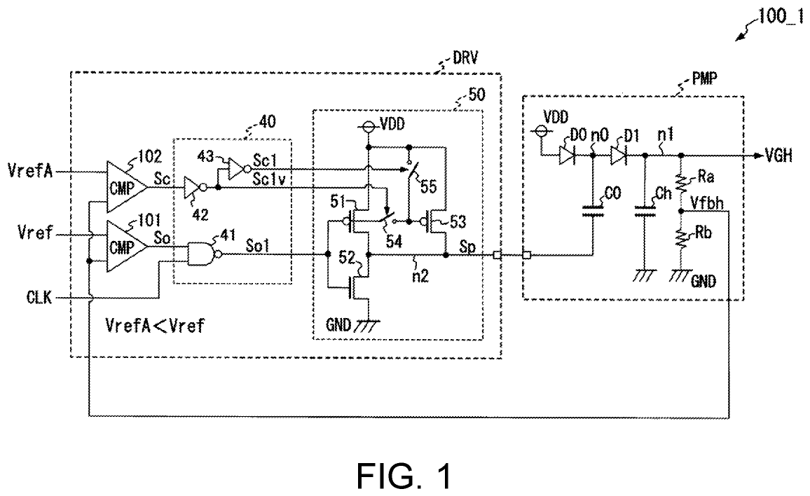

FIG. 1 is a circuit diagram showing a configuration of a charge pump circuit 100_1 as a first example according to the disclosure.

The charge pump circuit 100_1 is a boost circuit configured to generate an output voltage VGH where a voltage value reaches a predetermined target voltage value by receiving a power supply voltage VDD and boosting a voltage value of the power supply voltage VDD. The charge pump circuit 100_1 has a charge pump part PMP and a driving part DRV. Further, the output voltage VGH of the charge pump circuit 100_1 is supplied to a load circuit (not shown) as a boosted power supply voltage, and outputs current according to an operation of the load circuit.

The charge pump part PMP includes diodes D0 and D1, capacitors C0 and Ch, and resistors Ra and Rb.

The diode D0 receives the power supply voltage VDD at an anode thereof, and applies a voltage obtained by subtracting the forward voltage Vf thereof from the power supply voltage VDD to the anode of the diode D1 and one end of the capacitor C0 via a node n0. The cathode of the diode D1 is connected to one end of the capacitor Ch and one end of the resistor Ra via an output node n1. The other end of the resistor Ra is connected to one end of the resistor Rb, and a ground voltage GND is applied to the other end of the resistor Rb.

The charge pump part PMP outputs the voltage generated at the above-mentioned output node n1 as the output voltage VGH, and supplies the output voltage VGH divided by the resistors Ra and Rb to the driving part DRV as a return voltage Vfbh as shown by the following mathematical formula (1).

$$V fBh = V GH \cdot Rb / ( Ra + Rb ) \qquad ( 1 )$$

In addition, a target voltage of the output voltage VGH can be set by designating a target voltage of the return voltage Vfbh using a first reference voltage Vref according to mathematical formula (1). That is, the target voltage of the output voltage VGH is expressed by the following mathematical formula (2).

$$V GH = V ref \cdot ( Ra + Rb ) / Rb \qquad ( 2 )$$

Further, the other end of the capacitor C0 included in the charge pump part PMP is connected to the driving part DRV.

The driving part DRV is constituted by comparators 101 and 102, a control part 40 and an output buffer part 50.

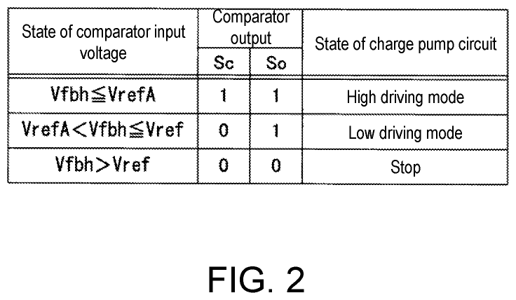

The comparator 101 receives the first reference voltage Vref having the predetermined voltage value corresponding to the target voltage value of the output voltage VGH and the above-mentioned return voltage Vfbh, and compares the magnitudes of the two. Here, as shown in FIG. 2, when the return voltage Vfbh is equal to or smaller than the reference voltage Vref, the comparator 101 supplies a first comparison result signal So of the logic level 1 to the control part 40. Meanwhile, when the return voltage Vfbh is greater than the reference voltage Vref, the comparator 101 supplies the comparison result signal So of the logic level 0 to the control part 40.

The comparator 102 receives a second reference voltage VrefA having a predetermined voltage value smaller than the reference voltage Vref and the above-mentioned return voltage Vfbh, and compares the magnitudes of the two. Here, as shown in FIG. 2, when the return voltage Vfbh is equal to or smaller than the reference voltage VrefA, the comparator 102 supplies a second comparison result signal Sc of the logic level 1 to the control part 40. Meanwhile, when the return voltage Vfbh is greater than the reference voltage VrefA, the comparator 102 supplies the comparison result signal Sc of the logic level 0 to the control part 40.

The control part 40 includes a NAND gate 41 as a first control circuit and inverters 42 and 43 as a second control circuit.

The NAND gate 41 receives a clock signal CLK as an oscillation signal that alternately repeats the state (the logic level 1) of the first voltage (VDD) and the state (the logic level 0) of the second voltage (GND) at a predetermined period, and the above-mentioned comparison result signal So. Here, the NAND gate 41 supplies the clock signal CLK to the output buffer part 50 as a charge pump control signal So1 while the comparison result signal So indicates the logic level 1. In addition, the NAND gate 41 supplies the charge pump control signal So1 fixed to the state of the logic level 1 to the output buffer part 50 while the comparison result signal So indicates the logic level 0.

The inverter 42 receives the above-mentioned comparison result signal Sc, and supplies a signal obtained by inverting the logic level of the comparison result signal Sc to the inverter 43 and the output buffer part 50 as a driving capability control signal Sc1v that indicates a current output capacity of the output buffer part 50. That is, the inverter 42 generates the driving capability control signal Sc1v of the logic level 0 that indicates a high driving mode when the comparison result signal Sc indicates that the return voltage Vfbh is equal to or smaller than the reference voltage VrefA, and supplies it to the inverter 43 and the output buffer part 50. Meanwhile, when the comparison result signal Sc indicates that the return voltage Vfbh is greater than the reference voltage VrefA, the driving capability control signal Sc1v of the logic level 1 that indicates the low driving mode is generated, and supplied to the inverter 43 and the output buffer part 50.

The inverter 43 supplies a signal obtained by inverting the logic level of the driving capability control signal Sc1v to the output buffer part 50 as a driving capability control signal Sc1.

The output buffer part 50 includes P-channel type transistors 51 and 53, an N-channel type transistor 52, and switching elements 54 and 55.

The transistor 51 receives the charge pump control signal So1 at a gate thereof, and receives the power supply voltage VDD at a source thereof. The transistor 52 receives the charge pump control signal So1 at a gate thereof, and receives the ground voltage GND at a source thereof. Drains of the transistors 51 and 52 are each connected to a node n2. Accordingly, the transistors 51 and 52 are complementarily set to an ON state on one side and an OFF state on the other side according to the charge pump control signal So1. Specifically, when the charge pump control signal So1 indicates the logic level 0, the transistor 51 is in the ON state, and the current is sent to the node n2 based on the power supply voltage VDD. Meanwhile, when the charge pump control signal So1 indicates the logic level 1, the transistor 52 is in the ON state, and the voltage at the node n2 reaches the ground voltage GND.

The switching element 54 is in the OFF state when the driving capability control signal Sc1v of the logic level 1 that designates the low driving mode is received. Meanwhile, when the driving capability control signal Sc1v of the logic level 0 that designates the high driving mode is received, the switching element 54 is in the ON state, and the charge pump control signal So1 is supplied to the gate of the transistor 53.

The switching element 55 is in the OFF state when the driving capability control signal Sc1 of the logic level 1 that designates the high driving mode is received. Meanwhile, when the driving capability control signal Sc1 of the logic level 0 that designates the low driving mode is received, the switching element 55 is in the ON state, and the power supply voltage VDD is supplied to the gate of the transistor 53.

The transistor 53 receives the power supply voltage VDD at a source thereof, and a drain thereof is connected to the node n2. The transistor 53 receives the charge pump control signal So1 at a gate thereof via the switching element 54 when the switching element 54 is in the ON state and the switching element 55 is in the OFF state. Here, the transistor 53 sends the current to the node n2 based on the power supply voltage VDD according to the charge pump control signal So1. Meanwhile, when the switching element 54 is in the OFF state and the switching element 55 is in the ON state, the transistor 53 is in the OFF state (non-active state), and the above-mentioned current sending operation to the node n2 is stopped.

Accordingly, the node n2 is in the state of the power supply voltage VDD or the ground voltage GND according to the above-mentioned operation of the transistors 51 to 53 and the switching elements 54 and 55.

The output buffer part 50 supplies the signal having voltage (VDD or GND) generated at the node n2 to the charge pump part PMP as a charge pump driving signal Sp.

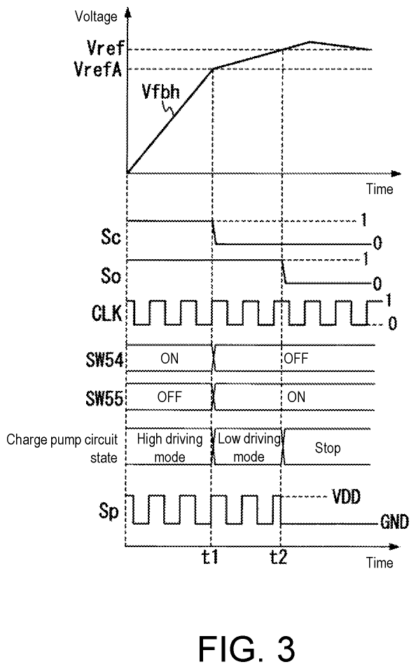

Hereinafter, the operation of the charge pump circuit 100_1 will be described with reference to the time chart shown in FIG. 3. Further, the output node n1 of the charge pump circuit 100_1 is connected to a load circuit (not shown), and the voltage VGH is supplied to the load circuit as a power supply voltage.

First, when the return voltage Vfbh corresponding to the output voltage VGH is smaller than the first reference voltage Vref, the transistors 51 and 52 are alternately in the ON state according to the clock signal CLK. Accordingly, the charge pump driving signal Sp, in which the states of the first voltage (VDD) and the second voltage (GND) appear alternately, is supplied to the other end of the capacitor C0 of the charge pump part PMP. Here, while the second voltage (GND) is applied to the other end of the capacitor C0 (charging period), the voltage at one end of the capacitor C0, i.e., the node n0, becomes a voltage (VDD-Vf) due to the forward voltage Vf of the diode DO. In addition, while the first voltage (VDD) is applied to the other end of the capacitor C0 (pump period), the voltage of the node n0 is boosted and a charging current is sent from the node n0 to the node n1 through the diode D1. Due to the charge pump operation in which charging/discharging of the capacitor C0 is repeated in the above-mentioned charging period and pump period, the voltage values of the output voltage VGH and the return voltage Vfbh are gradually increased as shown in FIG. 3. Here, due to the forward voltage Vf of the diode D1, the output voltage VGH is a voltage (2VDD-2Vf) as an upper limit as described below.

$$GND < V GH \leq 2 ( V DD - V f ) \qquad ( 3 )$$

That is, the output voltage VGH can generate a target voltage according to the first reference voltage Vref expressed as a mathematical formula (2) within a range of the above-mentioned equation (3).

Incidentally, when the return voltage Vfbh is equal to or smaller than the second reference voltage VrefA, the switching element 54 is in the ON state and the switching element 55 is in the OFF state according to the comparison result signal Sc of the logic level 1. Accordingly, the charge pump circuit 100_1 is in a state of the high driving mode in which the transistor 53 is activated together with the transistor 51 in the above-mentioned pump period and the current is sent to the node n2 from both the transistors. Due to the high driving mode, the voltage values of the output voltage VGH and the return voltage Vfbh increase relatively steeply.

After that, when the return voltage Vfbh exceeds the second reference voltage VrefA at a point of time t1 shown in FIG. 3, the switching element 54 is in the OFF state and the switching element 55 is in the ON state according to the comparison result signal Sc of the logic level 0. Accordingly, since the transistor 53 stops (inactivates) the operation, the charge pump circuit 100_1 is in a state of the low driving mode in which the current is sent to the node n2 by only the transistor 51 in the transistor 51 and 53. Accordingly, in the low driving mode after the point of time t1, as shown in FIG. 3, compared to the high driving mode, the voltage rise of the output voltage VGH and the return voltage Vfbh becomes gradual.

Then, when the return voltage Vfbh exceeds the first reference voltage Vref at a point of time t2 shown in FIG. 3, the transistor 52 is fixed to the ON state by the comparison result signal So fixed to the logic level 0, and the charge pump driving signal Sp is fixed to the ground voltage GND. Accordingly, since the charging/discharging operation by the capacitor C0 is stopped, a charge pump operation of the charge pump circuit 100_1 is stopped, and the voltage values of the output voltage VGH and the return voltage Vfbh are gradually decreased by the current output to the load circuit connected to a node n1.

Accordingly, after that, when the return voltage Vfbh is equal to or smaller than the first reference voltage Vref, it is shifted to the operation in the above-mentioned low driving mode again. The charge pump circuit 100_1 causes the voltage value of the output voltage VGH to converge to the target voltage value expressed by the mathematical formula (2) corresponding to the first reference voltage Vref by repeating the state of the low driving mode and the stopped state, and holds it to the capacitor Ch.

Here, in the charge pump circuit 100_1, in a process of boosting the voltage value of the power supply voltage VDD, after the voltage value of the return voltage Vfbh reaches the reference voltage VrefA lower than the reference voltage Vref corresponding to the target voltage value, driving capability to the charge pump part PMP is decreased by shifting from the high driving mode to the low driving mode.

That is, while the voltage value of the return voltage Vfbh reaches the reference voltage VrefA, the voltage value of the output voltage VGH is increased to the vicinity of the target voltage value quickly by driving the charge pump part PMP in the high driving mode. Then, after the voltage value of the return voltage Vfbh reaches the reference voltage VrefA, a rising speed of the output voltage VGH is decreased by switching from the high driving mode to the low driving mode, and then, the charge pump operation stops as the voltage value of the output voltage VGH exceeds the target voltage value.

Accordingly, the ripple generated at the output voltage VGH is reduced by decreasing the rising speed of the voltage value of the output voltage VGH before the target voltage value.

### Example 2

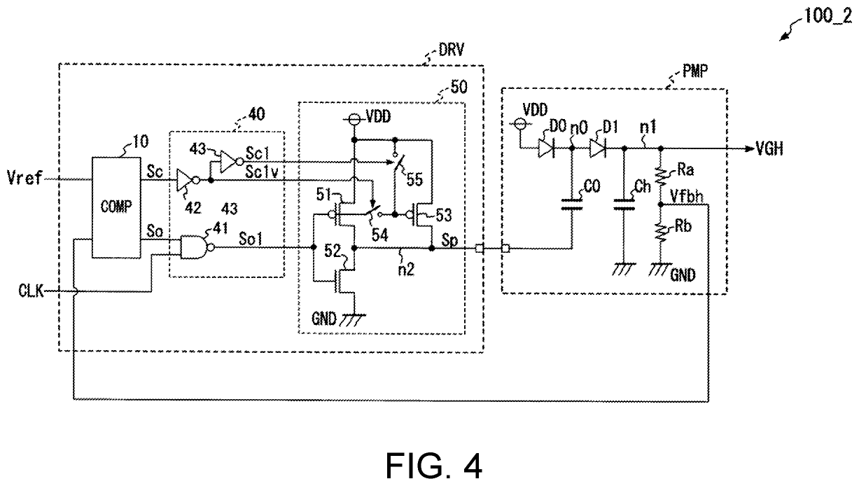

FIG. 4 is a circuit diagram showing a configuration of a charge pump circuit 100_2 as a second example according to the disclosure.

Further, in the charge pump circuit 100_2, a comparator circuit 10 is employed instead of the comparators 101 and 102 shown in FIG. 1, and the internal configurations and the operations of the control part 40, the output buffer part 50 and the charge pump part PMP are the same as in the charge pump circuit 100_1. Accordingly, like the charge pump circuit 100_1 even in the charge pump circuit 100_2, the ripple generated at the output voltage VGH generated by itself can be reduced.

The comparator circuit 10 has a combined function of the comparator 101 and the comparator 102 shown in FIG. 1.

That is, the comparator circuit 10 receives the first reference voltage Vref and the return voltage Vfbh. As shown in FIG. 2, the comparator circuit 10 generates the first comparison result signal So having the logic level 0 or 1 based on a magnitude correlation between the first reference voltage Vref and the return voltage Vfbh, and supplies it to the control part 40. Further, as shown in FIG. 2, the comparator circuit 10 generates the second reference voltage VrefA that is lower than the first reference voltage Vref by a predetermined voltage and the second comparison result signal Sc having the logic level 0 or 1 based on the magnitude correlation with the return voltage Vfbh, and supplies it to the control part 40.

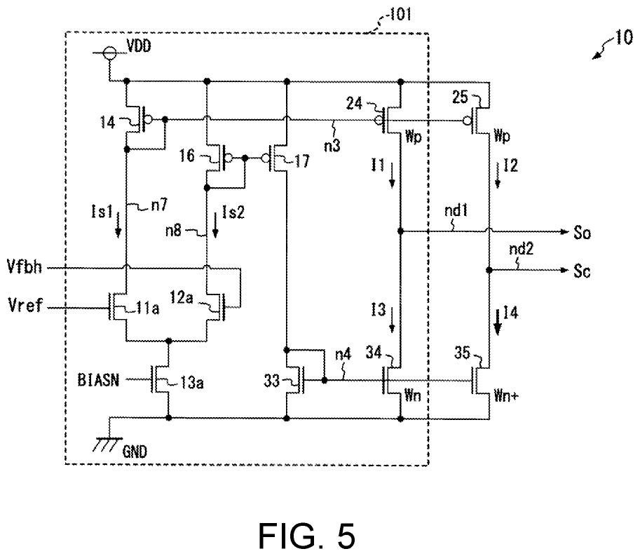

FIG. 5 is a circuit diagram showing an internal configuration of the comparator circuit 10.

As shown in FIG. 5, the comparator circuit 10 includes P-channel type transistors 14, 16, 17, 24 and 25, and N-channel type transistors 11a to 13a, 33 to 35.

The transistors 11a and 12a constitute a differential pair in which sources thereof are connected to each other. The transistor 11a receives the first reference voltage Vref at a gate thereof, and the transistor 12a receives the return voltage Vfbh at the gate. The sources of the transistors 11a and 12a are connected to a drain of the transistor 13a. A drain of the transistor 11a is connected to a drain and a gate of the transistor 14 via a node n7. The power supply voltage VDD is applied to the source of the transistor 14. The drain of the transistor 12a is connected to a drain and a gate of the transistor 16 via a node n8. The ground voltage GND is applied to the source of the transistor 13a, and tail current flows to the differential pair (11a, 12a) based on a predetermined bias voltage BIASN received at the gate. Further, FIG. 5 shows an example in which the differential pair is composed of N-channel type transistors though the conductivity type of the transistors constituting the differential pair can be either an N-channel type or a P-channel type.

The transistors 16 and 17 receive the power supply voltage VDD at the sources thereof, and the gates thereof are connected to each other. A drain of the transistor 17 is connected to a drain and a gate of the transistor 33.

The transistors 33 to 35 receive the ground voltage GND at sources thereof, and the gates are connected via a node n4.

The power supply voltage VDD is applied to the sources of the transistors 24 and 25, and the gates of the two are connected to the gate of the transistor 14 via a node n3.

The drains of the transistors 24 and 34 are connected via an output node nd1, and the voltage generated at the output node nd1 is output as the first comparison result signal So.

In addition, the drains of the transistors 25 and 35 are connected via an output node nd2, and the voltage generated at the output node nd2 is output as the second comparison result signal Sc.

Hereinafter, an operation of the comparator circuit 10 shown in FIG. 5 will be described.

First, the differential pair (11a, 12a) constituted by the transistors 11a and 12a receive the return voltage Vfbh and the reference voltage Vref, and a differential output current pair (Is1, Is2) corresponding to a voltage difference therebetween flows to the nodes n7 and n8.

Here, in the comparator circuit 10 shown in FIG. 5, the transistors 14, 24 and 25 constitute a first current mirror circuit (14, 24, 25), and the transistors 16, 17, and 33 to 35 constitute a second current mirror circuit (16, 17, 33 to 35).

The first current mirror circuit (14, 24, 25) generates a pair of source type differential output mirror currents I1 and I2 obtained by mirroring the differential output current Is1 with the same current mirror ratio, and sends them to the output nodes nd1 and nd2, respectively.

That is, the transistor 24 sends the source type differential output mirror current I1 obtained by mirroring the differential output current Is1 with a first current mirror ratio to the output node nd1. The transistor 25 sends the source type differential output mirror current I2 obtained by mirroring the differential output current Is1 with a first current mirror ratio to the output node nd2.

The second current mirror circuit (16, 17, 33 to 35) generates a pair of sink type differential output mirror currents I3 and I4 obtained by folding the differential output current Is2 and mirroring it with different current mirror ratios, and extracts the output nodes nd1 and nd2, respectively. That is, the transistor 34 subtracts the sink type differential output mirror current I3 obtained by mirroring the differential output current Is2 folded by the current mirror circuit (16, 17) with a second current mirror ratio from the output node nd1. Meanwhile, the transistor 35 subtracts the sink type differential output mirror current I4 obtained by mirroring the differential output current Is2 folded by the current mirror circuit (16, 17) with a third current mirror ratio greater than the second current mirror ratio from the output node nd2.

Accordingly, the source type differential output mirror current I1 and the sink type differential output mirror current I3 are coupled at the output node nd1, and the source type differential output mirror current I2 and the sink type differential output mirror current I4 are coupled at the output node nd2.

Here, the first and second current mirror ratios are set to values where the differential output mirror current I1 and the differential output mirror current I3 are equal to each other when the first reference voltage Vref and the return voltage Vfbh are substantially equal to each other.

Accordingly, as shown in FIG. 2, when the return voltage Vfbh is equal to or smaller than the reference voltage Vref, the power supply voltage VDD (the logic level 1) is provided from the output node nd1 to which the differential output mirror currents I1 and 13 are coupled, and when the return voltage Vfbh is greater than the reference voltage Vref, the comparison result signal So having the ground voltage GND (the logic level 0) is output.

In addition, the second and third current mirror ratios are set to values where the differential output mirror current I2 and the differential output mirror current I4 are equal to each other when the second reference voltage VrefA smaller than the first reference voltage Vref by a predetermined voltage is substantially equal to the return voltage Vfbh. For example, when the gate widths of the transistor 24 and 25 are set to the same gate width Wp, a gate width Wn+ of the transistor 34 is greater than a gate width Wn of the transistor 34.

Accordingly, as shown in FIG. 2, when the return voltage Vfbh is smaller than the reference voltage VrefA, the power supply voltage VDD (the logic level 1) is provided from the output node nd2 to which the differential output mirror currents I2 and I4 are coupled, and when the return voltage Vfbh is greater than the reference voltage VrefA, the comparison result signal Sc having the ground voltage GND (the logic level 0) is output.

Further, in the comparator circuit 10 shown in FIG. 5, the comparator 101 shown in FIG. 1 that generates the comparison result signal So is constituted by the transistors 11a to 13a, 14, 16, 17, 24, 33 and 34.

Furthermore, in the configuration shown in FIG. 5, the comparison result signal Sc that indicates the comparison result between the second reference voltage VrefA and the return voltage Vfbh is generated by coupling the sink type differential output mirror currents I2 and I4 obtained by mirroring the differential output current Is1 and Is2 generated in the comparator 101 with a current mirror ratio different from the case of the differential output mirror current I1 and I3. Further, while various current mirror ratios can be set, it is possible to obtain a comparison result signal (So, Sc) with the plurality of voltages (Vref, VrefA) using one reference voltage (Vref) by setting a ratio between the mirror current I1 and the mirror current I3 and a ratio between the mirror current I2 and the mirror current I4 to different values.

Here, in the configuration shown in FIG. 5, in generating the comparison result signal Sc, the transistors 11a to 13a, 14, 16, 17 and 33 that are components of the comparator 101 configured to generate the comparison result signal So are used. Accordingly, the only parts required to generate the comparison result signal Sc are the transistor 25 and 35 shown in FIG. 5. Further, according to the configuration of the comparator circuit 10 shown in FIG. 5, a circuit to generate the second reference voltage VrefA is no longer required.

Accordingly, according to the charge pump circuit 100_2 that employs the comparator circuit 10 shown in FIG. 5, like the charge pump circuit 100_1, it is possible to save area and power consumption compared to the case where the comparator 102 having the same circuit size as the comparator 101 is used together with the comparator 101.

Accordingly, according to the charge pump circuit 100_2, it is possible to save area and power consumption of the charge pump circuit while suppressing the ripple generated at the output voltage VGH.

### Example 3

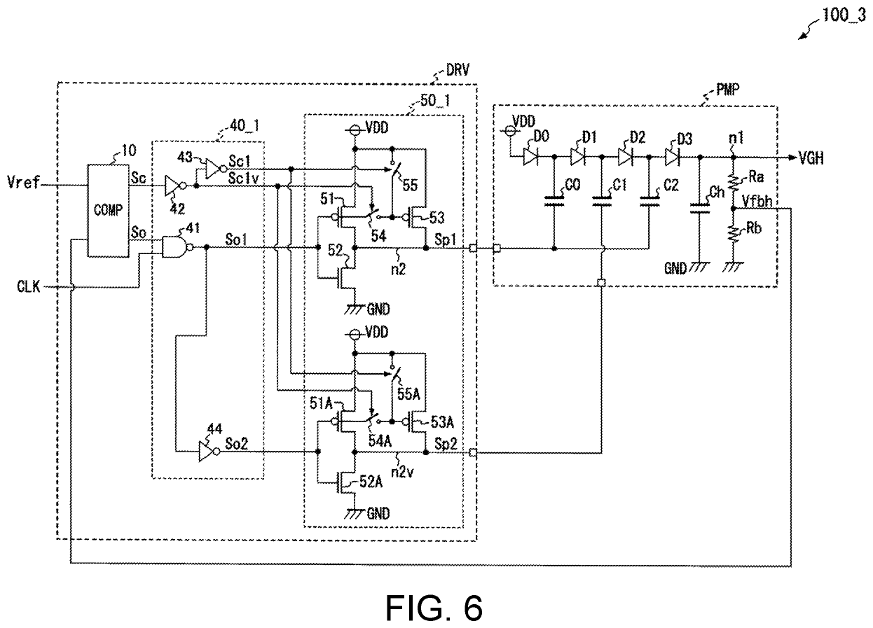

FIG. 6 is a circuit diagram showing a configuration of a charge pump circuit 100_3 as a third example according to the disclosure.

The charge pump circuit 100_3 is a boost circuit that boosts the power supply voltage VDD by about four times, unlike the boost circuit that boosts the power supply voltage VDD by about two times like the charge pump circuits 100_1 and 100_2.

As shown in FIG. 6, the charge pump circuit 100_3 is constituted by the driving part DRV and the charge pump part PMP, like the charge pump circuits 100_1 and 100_2 shown in FIG. 1 and FIG. 4. In addition, a target voltage of the output voltage VGH can be set by the mathematical formula (2).

However, in the charge pump part PMP of the charge pump circuit 100_3, the diodes D2 and D3 and the capacitor C1 and C2 are connected between the diode D1 and the output node n1 shown in FIG. 4. That is, an anode of the diode D2 and one end of the capacitor C1 are connected to a cathode of the diode D1, an anode of the diode D3 and one end of the capacitor C2 are connected to a cathode of the diode D2, and a cathode of the diode D3 is connected to the output node n1.

In addition, in the driving part DRV of the charge pump circuit 100_3, a control part 40_1 is employed instead of the control part 40 shown in FIG. 4, and an output buffer part 50_1 is employed instead of the output buffer part 50. Further, the comparator circuit 10 shown in FIG. 6 is the same as shown in FIG. 4.

The control part 40_1 is configured by adding an inverter 44 to the first control circuit with the NAND gate 41, and the inverters 42 and 43 as the second control circuit of the control part 40 shown in FIG. 4. The inverter 44 supplies a charge pump control signal So2 obtained by inverting the logic level of the charge pump control signal So1 output from the NAND gate 41 to the output buffer part 50_1.

The output buffer part 50_1 is configured by adding transistors 51A to 53A and switching elements 54A and 55A constituted by the same configuration as the transistor 51 to 53 and the switching elements 54 and 55 to the transistors 51 to 53 and the switching elements 54 and 55 of the output buffer part 50 shown in FIG. 4. However, in the output buffer part 50_1, the charge pump driving signal Sp generated by the transistor 51 to 53 and the switching elements 54 and 55 is supplied to the other end of each of the capacitors C0 and C2 of the charge pump part PMP as the first charge pump driving signal Sp1.

Further, the P-channel type transistor 51A shown in FIG. 6 receives the charge pump control signal So2 at a gate thereof, and receives the power supply voltage VDD at a source thereof. The transistor 52A receives the charge pump control signal So2 at a gate thereof, and receives the ground voltage GND at a source thereof. The transistors 51A and 52A are complementarily set to the ON state at one side and the OFF state on the other side according to the charge pump control signal So2. Specifically, when the charge pump control signal So2 indicates the logic level 0, the transistor 51A is in the ON state and the power supply voltage VDD is supplied to the node n2v. Meanwhile, when the charge pump control signal So2 indicates the logic level 1, the transistor 52A is in the ON state and the ground voltage GND is applied to the node n2v.

The switching element 54A receives the driving capability control signal Sc1v and is in the OFF state when the driving capability control signal Sc1v indicates the low driving mode. Meanwhile, the driving capability control signal Sc1v indicates the high driving mode, the switching element 54A is in the ON state and the charge pump control signal So2 is supplied to the gate of the transistor 53A. The switching element 55A receives the driving capability control signal Sc1, and is in the OFF state when the driving capability control signal Sc1 indicates the high driving mode. Meanwhile, when the driving capability control signal Sc1 indicates the low driving mode, the switching element 55A is in the ON state and the power supply voltage VDD is supplied to the gate of the transistor 53A.

The transistor 53A receives the power supply voltage VDD at a source thereof, and a drain thereof is connected to the node n2v. When the switching element 54A is in the ON state and the switching element 55A is in the OFF state, the transistor 53A receives the charge pump control signal So2 at a gate thereof via the switching element 54A. Here, the transistor 53A sends the current to the node n2v based on the power supply voltage VDD according to the charge pump control signal So2. Meanwhile, when the switching element 54A is in the OFF state and the switching element 55A is in the ON state, the transistor 53A is in the OFF state and in the non-active state in which the current sending operation to the node n2v is stopped.

Accordingly, due to the operations of the transistors 51A to 53A and the switching elements 54A and 55A, the node n2v is in a state of the power supply voltage VDD or the ground voltage GND.

The output buffer part 50_1 supplies the signal having the voltage (VDD or GND) generated at the node n2v to the other end of the capacitor C1 of the charge pump part PMP as the charge pump driving signal Sp2. Further, the charge pump driving signal Sp2 is obtained by inverting the phase of the charge pump driving signal Sp1. That is, the charge pump driving signal Sp2 is in the state of the second voltage (GND) while the charge pump driving signal Sp1 is in the state of the first voltage (VDD), and the charge pump driving signal Sp1 is in the state of the second voltage (GND) while the charge pump driving signal Sp2 is in the state of the first voltage (VDD).

According to the configuration shown in FIG. 6, the output voltage VGH output from the charge pump circuit 100_3 has a voltage (4VDD-4Vf) that is an upper limit as described below.

$$0 < V GH \leq 4 ( V DD - V f ) \qquad ( 4 )$$

That is, the output voltage VGH can generate a target voltage according to the first reference voltage Vref expressed by the mathematical formula (2) within a range of the mathematical formula (4).

Further, like the charge pump circuits 100_1 and 100_2 even in the charge pump circuit 100_3 shown in FIG. 6, in boosting the voltage value until the output voltage VGH reaches the target voltage value, the ripple generated at the output voltage VGH is suppressed by decreasing driving capability of the charge pump part PMP by the driving part DRV before the target voltage value.

Furthermore, in the charge pump circuit 100_3, like the charge pump circuit 100_2, it is possible to save area and power consumption by employing the comparator circuit 10 constituted by the configuration shown in FIG. 5 as the comparator that performs comparison of the two reference voltages (Vref, VrefA) with the return voltage Vfbh using one reference voltage (Vref).

### Example 4

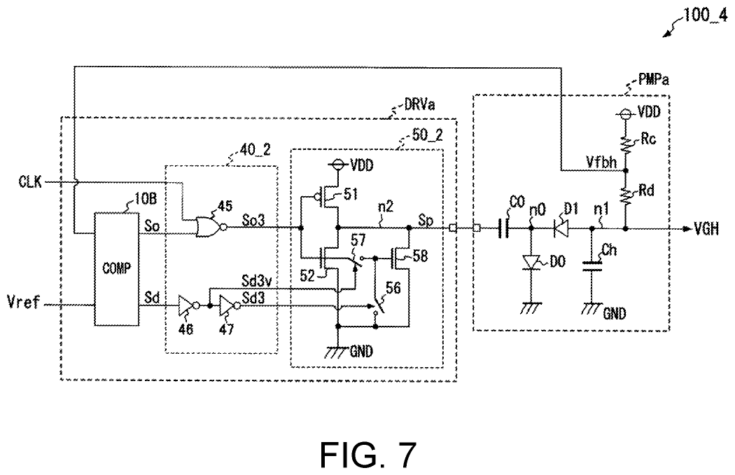

FIG. 7 is a circuit diagram showing a configuration of a charge pump circuit 100_4 as a fourth example according to the disclosure.

The charge pump circuit 100_4 is a step-down circuit that steps down the voltage value of the ground voltage GND with respect to the boost circuit such as the charge pump circuits 100_1 to 100_3.

As shown in FIG. 7, the charge pump circuit 100_4 is constituted by the driving part DRVa and the charge pump part PMPa.

The charge pump part PMPa includes diodes D0 and D1, capacitors C0 and Ch, and resistors Rc and Rd.

The capacitor C0 receives the charge pump driving signal Sp output from the driving part DRVa at one end thereof. The other end of the capacitor C0 is connected to an anode of the diode DO and a cathode of the diode D1 via the node no.

The ground voltage GND is applied to the cathode of the diode DO. The anode of the diode D1 is connected to one end of the capacitor Ch via the output node n1, and the ground voltage GND is applied to the other end of the capacitor Ch. The power supply voltage VDD is applied to one end of the resistor Rc, and the other end is connected to one end of the resistor Rd. The other end of the resistor Rd is connected to the output node n1.

Here, the voltage generated at the output node n1 is output as the output voltage VGH obtained by stepping down the voltage value of the ground voltage GND, and the voltage obtained by dividing the voltage between the output voltage VGH and the power supply voltage VDD using the resistors Rc and Rd is supplied to the driving part DRVa as the return voltage Vfbh.

The charge pump part PMPb outputs the voltage generated at the above-mentioned output node n1 as the output voltage VGH, and the voltage obtained by dividing the output voltage VGH using the resistors Rc and Rd expressed by the following mathematical formula is supplied to the driving part DRVb as the return voltage Vfbh.

$$V fbh = ( V GH \cdot Rc + V DD \cdot Rd ) / ( Rc + Rd ) \qquad ( 5 )$$

In addition, the target voltage of the output voltage VGH can be set by designating the target voltage of the return voltage Vfbh using the first reference voltage Vref from the mathematical formula (5). That is, the target voltage of the output voltage VGH is expressed by the following mathematical formula (6).

$$V GH = V ref \cdot ( Rc + Rd ) / Rc - V DD \cdot Rd / Rc \qquad ( 6 )$$

The driving part DRVa is constituted by a comparator circuit 10B, the control part 40_2 and the output buffer part 50_2. The comparator circuit 10B receives the first reference voltage Vref and the return voltage Vfbh.

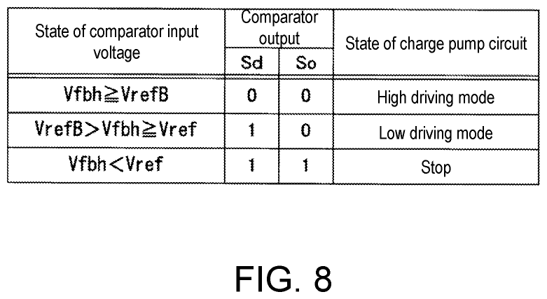

Then, as shown in FIG. 8, the comparator circuit 10B generates the first comparison result signal So having the logic level 0 or 1 based on the magnitude correlation between the first reference voltage Vref and the return voltage Vfbh, and supplies it to the control part 40_2. Further, as shown in FIG. 8, the comparator circuit 10B generates a second comparison result signal Sd having the logic level 0 or 1 based on the magnitude correlation between the second reference voltage VrefB greater than the first reference voltage Vref by a predetermined voltage and the return voltage Vfbh, and supplies it to the control part 40_2.

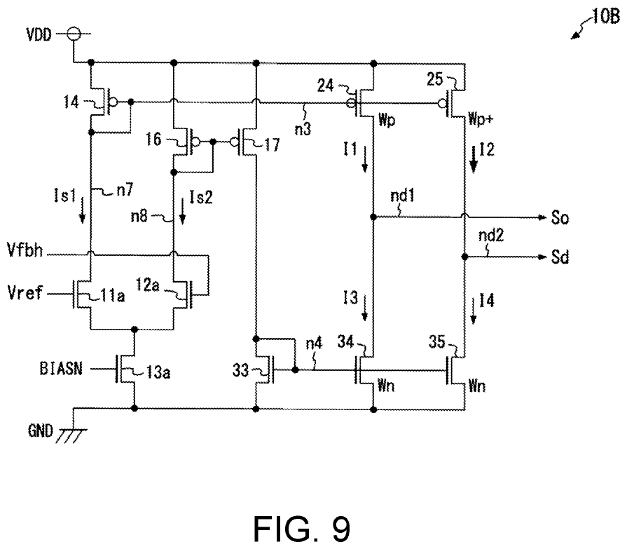

FIG. 9 is a circuit diagram showing a configuration of the comparator circuit 10B.

Further, as shown in FIG. 9, the comparator circuit 10B has a configuration in which the P-channel type transistors 14, 16, 17, 24 and 25, and the N-channel type transistors 11a to 13a, 33 to 35 are connected to the comparator circuit 10 shown in FIG. 5 in the same connection type.

In the comparator circuit 10B, like the comparator circuit 10, the differential pair (11a, 12a) causes the differential output current pair (Is1, Is2) corresponding to the voltage difference between the return voltage Vfbh and the reference voltage Vref to flow to the nodes n7 and n8.

Here, in the comparator circuit 10B, the first current mirror circuit (14, 24, 25) generates the pair of source type differential output mirror currents I1 and I2 obtained by mirroring the differential output current Is1 with different current mirror ratios, and sends them to the output nodes nd1 and nd2, respectively. That is, the transistor 24 sends the source type differential output mirror current I1 obtained by mirroring the differential output current Is1 with the first current mirror ratio to the output node nd1. The transistor 25 sends the source type differential output mirror current I2 obtained by mirroring the differential output current Is1 with a second current mirror ratio greater than the first current mirror ratio to the output node nd2.

The second current mirror circuit (16, 17, 33 to 35) folds the differential output current Is2, generates the pair of sink type differential output mirror currents I3 and I4 obtained by mirroring them with the same current mirror ratio, and extracts them from the output nodes nd1 and nd2. That is, the transistor 34 extracts the sink type differential output mirror current I3 obtained by mirroring the differential output current Is2 folded by the current mirror (16, 17) with a third current mirror ratio from the output node nd1. In addition, the transistor 35 extracts the sink type differential output mirror current I4 obtained by mirroring the differential output current Is2 folded by the current mirror (16, 17) with the third current mirror ratio from the output node nd2.

Accordingly, the source type differential output mirror current I1 and the sink type differential output mirror current I3 are coupled at the output node nd1, and the source type differential output mirror current I2 and the sink type differential output mirror current I4 are coupled at the output node nd2.

Here, the first and third current mirror ratios are set to values such that the differential output mirror current I1 and the differential output mirror current I3 are equal to each other when the first reference voltage Vref and the return voltage Vfbh are equal to each other.

Accordingly, as shown in FIG. 8, when the return voltage Vfbh is smaller than the reference voltage Vref, the power supply voltage VDD (the logic level 1) is provided from the output node nd1 to which the differential output mirror currents I1 and 13 are coupled, and when the return voltage Vfbh is equal to or greater than the reference voltage Vref, the comparison result signal So having the ground voltage GND (the logic level 0) is output.

In addition, the second and third current mirror ratios are set to values such that the differential output mirror current I2 and the differential output mirror current I4 are equal to each other when the second reference voltage VrefB greater than the first reference voltage Vref by the predetermined voltage is equal to the return voltage Vfbh. For example, when the transistors 34 and 35 having the same gate width Wn is employed, the transistor 25 having the gate width Wp+greater than the gate width Wp of the transistor 24 is employed.

Accordingly, as shown in FIG. 8, when the return voltage Vfbh is smaller than the second reference voltage VrefB, a comparison result signal Sd of the logic level 1 indicating the power supply voltage VDD, i.e., the low driving mode is output from the output node nd2 to which the differential output mirror currents I2 and I4 are coupled. Meanwhile, when the return voltage Vfbh is equal to or greater than the reference voltage VrefB, the comparison result signal Sd of the logic level 0 indicating the ground voltage GND, i.e., the high driving mode is output.

The comparator circuit 10B supplies the above-mentioned comparison result signal So and the comparison result signal Sd to the control part 40_2.

The control part 40_2 includes a NOR gate 45, and inverters 46 and 47.

The NOR gate 45 receives the clock signal CLK and the comparison result signal So. Here, the NOR gate 45 supplies an inverted clock signal obtained by inverting the logic level of the clock signal CLK to the output buffer part 50_2 as a charge pump control signal So3 while the comparison result signal So indicates the logic level 0. In addition, while the comparison result signal So indicates the logic level 1, the NOR gate 45 supplies the charge pump control signal So3 fixed to the state of the logic level 0 to the output buffer part 50_2.

The inverter 46 receives the comparison result signal Sd, and supplies a signal obtained by inverting the logic level of the comparison result signal Sd to the inverter 47 and the output buffer part 50_2 as a driving capability control signal Sd3v that indicates a current output capacity of the output buffer part 50_2. That is, the inverter 46 supplies the driving capability control signal Sd3v of the logic level 1 indicating the high driving mode to the inverter 47 and the output buffer part 50_2 when the comparison result signal Sd indicates the logic level 0 indicating that the return voltage Vfbh is equal to or greater than the second reference voltage VrefB. Meanwhile, when the comparison result signal Sd indicates the logic level 1 indicating that the return voltage Vfbh is smaller than the second reference voltage VrefB, the inverter 46 supplies the driving capability control signal Sd3v of the logic level 0 indicating the low driving mode to the inverter 47 and the output buffer part 50_2.

The inverter 47 supplies a signal obtained by inverting the logic level of the driving capability control signal Sd3v to the output buffer part 50_2 as a driving capability control signal Sd3.

The output buffer part 50_2 includes a P-channel type transistor 51, an N-channel type transistor 52, 58, and switching elements 56 and 57.

The transistor 51 receives the charge pump control signal So3 at a gate thereof, and receives the power supply voltage VDD at a source thereof. The transistor 52 receives the charge pump control signal So3 at a gate thereof, and receives the ground voltage GND at a source thereof. Both drains of the transistors 51 and 52 are connected to the node n2 together. Accordingly, the transistors 51 and 52 are complementarily set to the ON state at one side and the OFF state at the other side according to the charge pump control signal So3. Here, the power supply voltage VDD is supplied to the node n2 when the transistor 51 is in the ON state, and the ground voltage GND is applied to the node n2 when the transistor 52 is in the ON state.

The switching element 56 receives the driving capability control signal Sd3, and is in the OFF state when the driving capability control signal Sd3 indicates the logic level 0 that designates the high driving mode. Meanwhile, when the driving capability control signal Sd3 indicates the logic level 1 that designates the low driving mode, the switching element 56 is in the ON state and the ground voltage GND is supplied to the transistor 58.

The switching element 57 receives the driving capability control signal Sd3v, and is in the OFF state when the driving capability control signal Sd3v indicates the logic level 0 that designates the low driving mode. Meanwhile, when the driving capability control signal Sd3v indicates the logic level 1 that designates the high driving mode, the switching element 57 is in the ON state and the charge pump control signal So3 is supplied to the gate of the transistor 58.

The transistor 58 receives the ground voltage GND at a source thereof, and a drain thereof is connected to the node n2. The transistor 58 receives the charge pump control signal So3 at a gate thereof via the switching element 57 when the switching element 57 is in the ON and the switching element 56 is in the OFF state. Here, the transistor 58 extracts the current from the node n2 based on the charge pump control signal So3. Meanwhile, when the switching element 57 is in the OFF state and the switching element 56 is in the ON state, the transistor 58 is in the OFF state and is in the non-active state in which the current extracting operation from the node n2 is stopped.

Accordingly, due to the operations of the transistors 51, 52 and 58, and the switching elements 56 and 57, the node n2 is in the state of the power supply voltage VDD or the ground voltage GND.

The output buffer part 50_2 supplies a signal having the voltage (VDD or GND) generated at the node n2 to the charge pump part PMPa as the charge pump driving signal Sp.

According to the configuration shown in FIG. 7, in the charge pump circuit 100_4, when the return voltage Vfbh according to the output voltage VGH is greater than the first reference voltage Vref, the transistors 51 and 52 are alternately in the ON state according to the clock signal CLK. Accordingly, the charge pump driving signal Sp where the states of the first voltage (VDD) and the second voltage (GND) appear alternately is supplied to the other end of the capacitor C0 of the charge pump part PMPa. Accordingly, the charging/discharging is repeated by the capacitor C0, and thus, the voltage values of the output voltage VGH and the return voltage Vfbh are gradually lowered. Here, the output voltage VGH is a voltage with negative polarity, which is a lower limit voltage (−VDD+2Vf) as described below.

$$- V DD + 2 V f \leq V GH < V DD \qquad ( 7 )$$

That is, the output voltage VGH can generate a target voltage according to the first reference voltage Vref expressed by the mathematical formula (6) within a range of the above-mentioned equation (7).

Here, when the return voltage Vfbh is equal to or greater than the second reference voltage VrefB, the switching element 57 is in the ON state and the switching element 56 is in the OFF state according to the comparison result signal Sd of the logic level 0. Accordingly, the transistor 52 and 58 are activated together to perform extraction of the current from the node n2 by both the transistors, and the charge pump circuit 100_4 is in the state of the high driving mode as shown in FIG. 8. According to the high driving mode, the output voltage VGH and the return voltage Vfbh decrease the voltage value relatively steeply.

After that, when the return voltage Vfbh is smaller than the second reference voltage VrefB, the switching element 57 is in the OFF state and the switching element 56 is in the ON state according to the comparison result signal Sd of the logic level 1 indicating the low driving mode. Accordingly, since the current extracting operation from the node n2 by the transistor 58 is stopped (non-activated), the charge pump circuit 100_4 is in the state of the low driving mode in which the current activated by only the transistor 52 in the transistor 52 and 58 is extracted from the node n2. In the low driving mode, a voltage lowering speed of the output voltage VGH and the return voltage Vfbh is more gently decreased than upon the high driving mode.

Then, when the return voltage Vfbh is smaller than the first reference voltage Vref, the transistor 51 is fixed to the ON state by the comparison result signal So fixed to the logic level 1, and the charge pump driving signal Sp is fixed to the power supply voltage VDD. Accordingly, since the charging/discharging of the capacitor C0 is stopped, the charge pump operation (step-down operation) by the charge pump circuit 100_4 is stopped, and the voltage values of the output voltage VGH and the return voltage Vfbh are gradually increased due to inflow of the current from the load circuit (not shown) connected to the node n2.

Accordingly, after that, when the return voltage Vfbh is equal to or greater than the first reference voltage Vref, it shifts to the operation in the low driving mode again. The charge pump circuit 100_4 causes the voltage value of the output voltage VGH to converge to the target voltage value expressed by the mathematical formula (6) corresponding to the first reference voltage Vref by repeating the state of the low driving mode and the stop state, and holds it to the capacitor Ch.

Here, in the charge pump circuit 100_4, in a process of stepping down the voltage value of the ground voltage GND, after the voltage value of the return voltage Vfbh reaches the reference voltage VrefB greater than the reference voltage Vref corresponding to the target voltage value, driving capability with respect to the charge pump part PMPa is decreased due to the shift from the high driving mode to the low driving mode.

That is, while the voltage value of the return voltage Vfbh reaches the reference voltage VrefB, the voltage value of the output voltage VGH is rapidly lowered to the vicinity of the target voltage value by driving the charge pump part PMPa in the high driving mode. Then, after the voltage value of the return voltage Vfbh reaches the reference voltage VrefB, a lowering speed of the output voltage VGH is decreased by switching from the high driving mode to the low driving mode, and then, the charge pump operation is stopped as the voltage value of the output voltage VGH is smaller than the target voltage value.

Accordingly, the ripple generated at the output voltage VGH is reduced by decreasing the lowering speed of the voltage value of the output voltage VGH before the target voltage value.

Further, in the charge pump circuit 100_4, as the comparator that performs comparison of the two reference voltages (Vref, VrefB) with the return voltage Vfbh, the comparator circuit 10B constituted by substantially the same circuit configuration as the comparator circuit 10 shown in FIG. 5 is employed. Accordingly, it is possible to save area and power consumption of the charge pump circuit.

Further, in the output buffer part 50, 50_1 or 50_2 shown in FIG. 1, FIG. 4, FIG. 6 or FIG. 7, the two transistors connected in parallel are activated upon the high driving mode, and one of the two transistors is non-activated upon the low driving mode. However, the number of the transistors connected in parallel is not limited to two.

In short, as the output buffer part, a configuration including a plurality of transistors that receive the charge pump control signal (So1 to So3) at a gate thereof, send the current to the node n2 (n2v) based on the charge pump control signal or extracting the current from the node may be employed. Here, when the driving capability control signal (Sc, Sd) indicates the high driving mode, all the plurality of transistor are activated, and when indicating the low driving mode, at least one of the plurality of transistors is non-activated.

In addition, similarly, even in the charge pump circuit, it is not limited to the configuration of the charge pump circuits 100_1 to 100_4 shown in FIG. 1, FIG. 4, FIG. 6 or FIG. 7.

In short, as the charge pump circuit of stepping up or down the voltage until the voltage of the output node reaches the target voltage value and outputting the voltage of the output node as the output voltage (VGH) by deriving the voltage generated in the capacitor to the output node (n1) while repeatedly charging/discharging of the capacitor (C0) according to the charge pump driving signal (Sp), a circuit including the following comparator circuit, the first and second control circuits, and the output buffer may be provided.

The comparator circuit (10, 10B) compares the magnitudes of the return voltage (Vfbh) and the first reference voltage (Vref), whose voltage value is changed according to the output voltage (VGH), and generates the first comparison result signal (So) that indicates whether the return voltage exceeds the first reference voltage. Further, the second comparison result signal (Sc, Sd) indicating whether the return voltage exceeds the second reference voltage (VrefA, VrefB) by comparing the magnitudes of the second reference voltage corresponding to the voltage value before the target voltage value with the return voltage is generated.

The first control circuit (41, 45) generates the charge pump control signal (So1 to So3) that stops the charging/discharging of the capacitor (C0) when the first comparison result signal indicates that the return voltage exceeds the first reference voltage, and generates an oscillation signal (CLK) that performs charging/discharging of the capacitor when indicating that the return voltage does not exceed the first reference voltage as the charge pump control signal.

The second control circuit (42, 43, 46, 47) generates the driving capability control signal (Sc1, Sc1v, Sd3, Sd3v) that indicates the low driving mode when the second comparison result signal (Sc, Sd) indicates that the return voltage exceeds the second reference voltage, and indicates the high driving mode when indicating that the return voltage does not exceed the second reference voltage.

The output buffer (50, 50_1, 50_2) outputs the signal obtained by amplifying the charge pump control signal via the second node (n2, n2v) as the charge pump driving signal, and reduces the current flowing to the second node compared to the case showing the high driving mode when the driving capability control signal indicates the low driving mode.

### Example 5

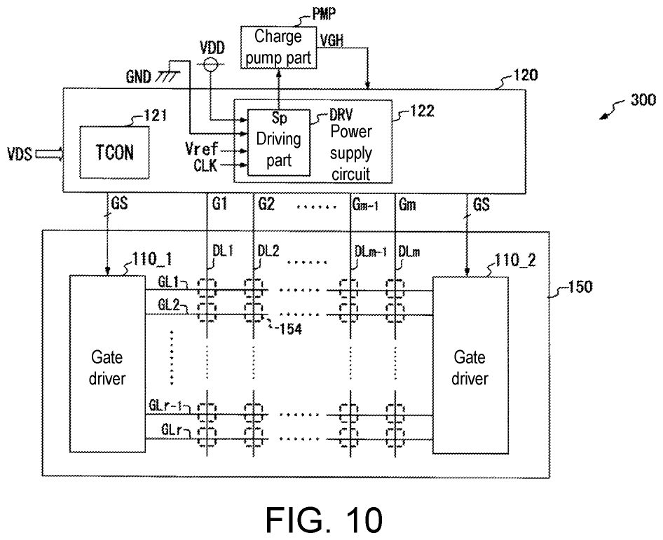

FIG. 10 is a block diagram showing a schematic configuration of a display device 300 including the above-mentioned charge pump circuit 100_1, 100_2 or 100_3.

As shown in FIG. 10, the display device 300 includes a display panel 150, a data driver 120 configured to drive the display panel 150, and the charge pump part PMP included in the charge pump circuit 100_1, 100_2 or 100_3 as an external part of the data driver 120.

The display panel 150 has gate lines GL1 to GLr (r is an integer of 2 or more) disposed in a horizontal direction of a screen, and data lines DLI to DLm (m is an integer of 2 or more) disposed across the gate lines. Further, a display cell 154 corresponding to each pixel is formed on a crossing part of each of the gate lines GL1 to GLr and each of the data lines DLI to DLm.

Further, gate drivers 110_1 and 110_2 formed integrally with the display panel 150 are disposed on the display panel 150. The gate drivers 110_1 and 110_2 have a thin film transistor circuit configuration in which the gate lines GL1 to GLr and the data lines DLI to DLm are integrally formed on an insulating substrate such as glass, plastic, or the like.

The gate driver 110_1 is connected to one end of each of the gate lines GL1 to GLr, and the gate driver 110_2 is connected to the other end of each of the gate lines GL1 to GLr. The gate drivers 110_1 and 110_2 generate gate selection signals at a timing expressed in a gate timing signal group GS supplied from the data driver 120, and sequentially and selectively supply them to one end of each of the gate lines GLr to GL1.

The data driver 120 is constituted by, for example, a single or a plurality of semiconductor IC chips, and mounted on the display panel 150 such as a chip on glass (COG), a chip on film (COF), or the like.

In addition, the data driver 120 includes a display controller (TCON) 121 configured to receive the video data signal VDS, the power supply voltage VDD and the ground voltage GND, and extracts or generates a series of pixel data pieces expressing a luminance level of each pixel from the video data signal VDS and various control signals such as a clock signal, horizontal and vertical synchronization signals, or the like, and a power supply circuit 122.

The data driver 120 generates the gate timing signal group GS at the timing of the horizontal synchronization signal and supplies it to the gate drivers 110_1 and 110_2. Further, the data driver 120 takes in the series of pixel data pieces for one horizontal scanning line (m pieces) according to the various control signals described above, and converts each of them into driving signals G1 to Gm having an analog voltage value. Then, the data driver 120 supplies the driving signals G1 to Gm to the data lines DLI to DLm.

The power supply circuit 122 has the driving part DRV included in the charge pump circuit 100_1, 100_2 or 100_3 shown in FIG. 1, FIG. 4 or FIG. 6. The driving part DRV receives the power supply voltages VDD and GND received by the data driver 120, and the clock signal CLK and the reference voltage Vref generated in the data driver 120. The driving part DRV generates the above-mentioned charge pump driving signal Sp based on the power supply voltage VDD and GND, the clock signal CLK and the reference voltage Vref. The charge pump driving signal Sp is supplied to the capacitor C0 of the charge pump part PMP shown in, for example, FIG. 4, externally attached to the data driver 120 via the external terminal of the data driver 120. Here, the charge pump part PMP externally attached to the data driver 120 generates the output voltage VGH according to the charge pump driving signal Sp supplied from the data driver 120, and supplies it to the data driver 120. The power supply circuit 122 receives the output voltage VGH, generates the circuit group (not shown) that generates the gate timing signal group GS and the driving signals G1 to Gm, and the power supply voltage that operates the display controller 121 based on the output voltage VGH, and supplies them to the above-mentioned circuit group and the display controller 121.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A charge pump circuit comprising a capacitor and configured to step up or down a voltage of an output node to reach a target voltage value and output the voltage of the output node as the output voltage by deriving a voltage generated at a first node of one end of the capacitor to the output node while repeatedly charging/discharging the capacitor according to a charge pump driving signal, the charge pump circuit comprising:
a comparator circuit configured to compare magnitudes of a return voltage, whose voltage value changes according to the output voltage, and a first reference voltage corresponding to the target voltage value to generate a first comparison result signal indicating whether the return voltage exceeds the first reference voltage, and compare magnitudes of a second reference voltage corresponding to a voltage value before the target voltage value and the return voltage to generate a second comparison result signal indicating whether the return voltage exceeds the second reference voltage;
a first control circuit configured to generate a charge pump control signal that stops charging/discharging of the capacitor when the first comparison result signal indicates that the return voltage exceeds the first reference voltage, and an oscillation signal that performs charging/discharging of the capacitor when the first comparison result signal indicates that the return voltage does not exceed the first reference voltage as the charge pump control signal;
a second control circuit configured to generate a driving capability control signal that indicates a low driving mode when the second comparison result signal indicates that the return voltage exceeds the second reference voltage and a high driving mode when the second comparison result signal indicates that the return voltage does not exceed the second reference voltage; and
an output buffer configured to output a signal obtained by amplifying the charge pump control signal via a second node as the charge pump driving signal,
wherein the output buffer reduces current flowing to the second node when the driving capability control signal indicates the low driving mode compared to the case of indicating the high driving mode.

2. The charge pump circuit according to claim 1, wherein the comparator circuit comprises:
a differential pair configured to output a first differential output current and a second differential output current corresponding to a difference between the first reference voltage and the return voltage;
a first current mirror circuit configured to generate a first mirror current and a second mirror current of 2 systems of a source type obtained by mirroring the first differential output current and send the first mirror current to a first output node and the second mirror current to a second output node; and
a second current mirror circuit configured to generate a third mirror current and a fourth mirror current of 2 systems of a sink type obtained by mirroring the second differential output current and extract the third mirror current from the first output node and the fourth mirror current from the second output node,
wherein the first to fourth mirror currents are set such that a ratio between the first mirror current and the third mirror current and a ratio between the second mirror current and the fourth mirror current are different, and
a voltage generated at the first output node obtained by coupling the first mirror current and the third mirror current at the first output node is output as the first comparison result signal and a voltage generated at the second output node obtained by coupling the second mirror current and the fourth mirror current at the second output node is output as the second comparison result signal.

3. The charge pump circuit according to claim 2, wherein current mirror ratios of the first mirror current and the second mirror current with respect to the first differential output current in the first current mirror circuit are equal to each other, and
a current mirror ratio of the fourth mirror current with respect to the second differential output current in the second current mirror circuit is greater than a current mirror ratio of the third mirror current with respect to the second differential output current.

4. The charge pump circuit according to claim 2, wherein a current mirror ratio of the second mirror current with respect to the first differential output current in the first current mirror circuit is greater than a current mirror ratio of the first mirror current with respect to the first differential output current, and
current mirror ratios of the third mirror current and the fourth mirror current with respect to the second differential output current in the second current mirror circuit are equal to each other.

5. The charge pump circuit according to claim 1, wherein the output buffer includes a plurality of transistors each configured to receive the charge pump control signal at a gate of its own and send a current to the second node or extract the current from the second node based on the charge pump control signal, and
most of the plurality of transistors are activated when the driving capability control signal indicates the high driving mode, and at least one of the transistors activated in the high driving mode is deactivated when the driving capability control signal indicates the low driving mode.

6. A display driver configured to drive a display panel on which a plurality of display cells are disposed based on a video signal, the display driver comprising:
a circuit group configured to generate a signal group that drives the display panel and supply the signal group to the display panel, and
a power supply circuit including the charge pump circuit according to claim 3 and configured to generate a power supply voltage that operates the circuit group based on the output voltage output from the charge pump circuit.

7. A display device having a display panel on which a plurality of display cells are disposed, and a display driver configured to generate a signal group that drives the display panel based on a video signal, the display driver comprising:
a circuit group configured to generate a signal group that drives the display panel and supply the signal group to the display panel, and
a power supply circuit including the charge pump circuit according to claim 3 and configured to generate a power supply voltage that operates the circuit group based on the output voltage output from the charge pump circuit.
